(19) United States
(12) Patent Application Publication
(10) Pub. No.: US 2024/0061097 A1
(43) Pub. Date: Feb. 22, 2024

(54) POSITIONING SYSTEM, METHOD AND COMPUTER PROGRAM PRODUCT UTILIZING INPUTS FROM GEOSTATIONARY COMMUNICATION SATELLITES

(71) Applicant: Elta Systems Ltd., Ashdod (IL)

(72) Inventors: Moshe FIREAIZEN, Kfar Saba (IL); Yiftah LIPKIN, Kfar Saba (IL); Aharon RAZON, Tel-Aviv (IL); Michael ELMAKIAS, Ashdod (IL)

(21) Appl. No.: 18/259,337

(22) PCT Filed: Dec. 13, 2021
(86) PCT No.: PCT/IL2021/051484

§ 371 Date: Jun. 26, 2023

(30) Foreign Application Priority Data
Dec. 31, 2020 (IL) 279913

(51) Int. Cl. G01S 13/76

(52) U.S. Cl. CPC G01S 13/765

(57) ABSTRACT

A navigation system comprising at least one terminal configured to at least once transmit, to a communicant, e.g. via n>=1 satellite/s, a request for a reply transmission and wherein the communicant, responsively, at least once transmits a response transmission to the terminal. The terminal measures the response transmission's time of arrival and/or round-trip time and determines a round-trip time characterizing the terminal's own communication, via each of the satellite/s, with the communicant, and/or the terminal's own range (aka distance) from each of the satellite/s. The terminal is configured to derive self-orientation data from at least said round-trip time and from internal delay data characterizing the at least one satellite and/or the communicant.

### FIELD OF THIS DISCLOSURE

The present invention relates generally to satellites, and more particularly to geostationary communication satellites.

### BACKGROUND FOR THIS DISCLOSURE

Conventional technology constituting background to certain embodiments of the present invention is described in the following publications inter alia:

Regional Positioning System Using Turksat Satellites, by Ahmet Fazil Yagli, Mesut Gokten, Senol Gulgonul, Ibrahim Oz, Ozkan Dalbay, R&D and Satellite Design Dept. TURK SAT of Ankara, Turkey. Available online at https://www.researchgate.net/publication/261242333,

describes a “positioning system using three geosynchronous Turksat satellites . . . . In this system, a time code signal sent from an earth station to three geostationary satellites is received by a user on Earth. Time delay differences from three satellites are measured by the user and are used to calculate the user's position. The user's location information includes latitude and longitude coordinates. It is assumed that the user's altitude is measured by an altimeter.”

Geostationary Satellite Navigation Systems By Tri T. Ha And R. Clark Robertson describes “position determination using geostationary satellites as an alternative to the global positioning system (GPS) . . . . The advantage of a geostationary system is that only three, or at most four, satellites are required to cover the continental United States. A total of twelve satellites are sufficient for global coverage (excluding polar regions), or eight if only longitude and latitude, but not altitude, are measured. The system involves the determination of the range to either four geostationary satellites or, if the altitude is not measured, three geostationary satellites.”

The Beidou satellite navigation system is described in:
Yu Jia. Positioning Method by Two Geostationary Satellites and Beidou 1 Satellite Navigation System[J]. Spacecraft Recovery & Remote Sensing, 2004, 25(1):65.
   Or:
   https://gssc.esa.int/navipedia/index.php/Other_Regional_Systems#cite_ref-Chinese_today_1-1
   or
   https://directory.eoportal.org/web/eoportal/satellite-missions/content/-/article/cnss.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a system for self orientation (synchronization and/or navigation) in which the navigation terminal aka terminal aka self-orienting terminal initiates a synchronization and/or navigation ‘transaction’, computes its own position, uses TOA (time of arrival) or measures round-trip time, and/or measures doppler shifts, to derive its position and/or to synch, and uses Geostationary communication satellites aka GEO comm SAT. The navigation terminal may optionally perform the above on its own, with no station in the loop (aka “NSIL embodiment”). The navigation system may use at least 2 satellites, each of which provide either downlink or uplink, but need not provide both. Typically, at least one satellite provides downlink, and at least one other satellite provides uplink. Typically, the terminal sends a single “trigger transmission” and the station, responsively, sends multiple, timed replies through different satellites respectively, and/or at multiple times respectively. This is advantageous because only a minimum of transmissions (e.g. a single transmission) is required from the terminal and still, plural replies over time are obtained from the station. Thus if different satellites are used for each reply, there is no need for a duplex link with each satellite since, instead, a navigation system using at least 3 satellites, all of which provide either downlink or uplink, but not both, may be provided; at least one satellite can then provide downlink, and at least one other satellite can provide uplink.

Typically, both in the no-station-in-loop (NSIL) embodiment and in “SIL or station-in-the-loop” embodiments which do employ a station, navigation is achieved by the terminal which initiates a NAV measurement by sending a message to the satellite and registering the transmission time. the terminal receives a message from the satellites, and measures the “transaction time” (difference between reception and transmission times). from the “transaction time”, the terminal estimates the satellite range, by deriving the “round-trip time” (the signal travel-time from the terminal to the satellite, and back, which is equal to twice the travel time between the terminal and the satellite). the terminal uses (at least) two sat-range+one altitude estimations, or (at least) three sat-range estimations to derive its position. to derive its self-position, information (“additional data”) may be transferred to the terminal e.g. temporal information (e.g. satellite internal delay) as well as spatial information. the spatial info typically includes the satellites' positions, which is used for self-positioning. The information transferred to the terminal may be loaded to the terminal at a prior time, or may be transmitted to the terminal e.g. by long-wave transmission, or via satellite, typically with a refresh rate that depends on the quality of a GEO-SAT propagator calculator onboard the terminal, and the desired NAV accuracy.

Typically the NSIL embodiment employs transceiving satellites e.g. the terminal is illuminated by both downlink and uplink beams of the satellite. SIL however, may be accomplished using combinations of transceiving/downlink-only/uplink-only satellites. in the NSIL embodiment, the terminal typically receives, from the satellite, its own message, which is relayed back to it. in SIL embodiments, the terminal typically receives a reply message from the station. in NSIL, the “round-trip time” is typically derived by subtracting from the “transaction time” the satellite internal delay. In SIL, the “round-trip time” is typically derived by subtracting the time elapsed from the reception of the terminal's transmission by the satellite to the time the station's reply message is relayed by the satellite to the terminal (“SAT-STATION-SAT time”). In NSIL, the satellites' positions is typically the only spatial information required, and the only temporal information required is the internal delays of the satellites, used to determine ranges. In SIL, the terminal typically obtains the SAT-STATION-SAT time either from the SAT-STATION-SAT time and/or from the station's positions and the station & satellite internal delays. in SIL, the ADDITIONAL DATA may be sent to the terminal, encoded in the reply message which typically does not occur in the NSIL embodiment where there is no reply message from a station. IN NSIL, synchronization (“SYNC”) typically involves the terminal knowing the range to the satellite and some station regularly broadcasting a time stamp that corresponds to the broadcast time of the message is re-transmitted from the satellite. In SIL, synchronization (“SYNC”) typically involves the terminal measuring the “transaction time” and the central station broadcasting a time stamp that corresponds to mid-time between the station reception and transmition times.

Certain embodiments seek to provide a more parsimonious method for utilizing Geostationary Communication Satellites whose orbital period equals the Earth's rotational period, hence they appear from the ground to be stationary.

Certain embodiments seek to utilize active (duplex, or at least either downlink or uplink) communication via satellites e.g. geostationary communication satellites, for self-positioning and/or synchronization.

Certain embodiments seek to provide a transceiving ground station, at least two additional receiving or transmitting ground stations which are not co-located either with each other or with the transceiving ground station, and at least two additional (passive e.g. downlink-only) stations.

According to certain embodiments, active range measurement is provided for 3 stations. Each station measures time elapsed between transmission and reception, then subtracts the satellite delay and the station delay, then divides by 2 to yield the net round-trip travel time, and multiplies by c, the speed of light, to obtain the satellite range. Times of measurement need not be synchronized. Range data may be passed to a suitable central processor, e.g. via satellite, which may be incorporated into an estimation of the satellite's position. Partial or full knowledge of the position of the satellites is useful for the time-synchronization method and the position/navigation methods described below.

According to certain embodiments, the distance between the three ranging stations is large, typically large enough to yield fair (e.g. depending on the use case) GDOP value of the stations with respect to the satellite.

Even if the distance between the three ranging stations is small, yielding poor GDOP value of the stations with respect to the satellite, this typically does not preclude the use of the time-synchronization and the position/navigation methods described below, particularly in the vicinity of the ranging station, wherein the GDOP has only a slight effect on the navigation accuracy.

According to certain embodiments, active range measurement occurs at one station; the signals transmitted by the first station, which may include a time stamp representing the transmission time, and relayed from the satellite, are received also by 2 additional passive stations that may be synchronized (e.g. 1 pps) with the first station. The active station measures the range e.g. in the manner described in the previous embodiment. The passive stations typically measure the range e.g. by subtracting the time-stamp from the signal reception time, and then using the method of the previous embodiment. The system may require range measurements to be passed to the central processor, e.g. for processing and/or distribution via satellite.

According to certain embodiments, active range measurement occurs at one station. Signals which are transmitted from two additional transmitting-only stations, which may include a time stamp representing the transmission time, and relayed from the satellite, may be received at the first station that is synchronized (e.g. 1 pps) with the other two stations. The first station typically measures the range e.g. in the manner described in the previous embodiment. The first station may, e.g. also measure the range from the two transmitting-only stations by subtracting the timestamp from the signal reception time, and then following the method described in the previous embodiment. The system may require range measurements to be passed to the central processor, e.g. for processing and/or distribution via satellite.

Direction may be measured, e.g. together with active range measurement, e.g. from the same station or from a different location, e.g. using a telescope.

It is appreciated that embodiments herein avail themselves of satellites only parsimoniously e.g. using 1, 2 or 3 satellites rather than 4.

When using 1 satellite (or more), terminals may communicate with a central processor. Each terminal may transmit a message to the central processor and may receive a return message containing information about systems' delays and a timestamp representing either the central processor reception time or the central processor transmission time. These data may be used by the terminals to synchronize their time base with that of the central processor, and thus to obtain synchronization among all terminals connected to the central processor. The terminals need not necessarily all communicate with the central processor via the same satellite.

When using only 2 satellites, a terminal may communicate with a central processor and receive its own position and/or the time at which its signal was received and/or the time at which the signal being transmitted back to him was transmitted, which is indicative of delay at the central processor.

According to certain embodiments, when using only 3 satellites, all communication between the 3 satellites and the terminals may be via the central processor only.

Active measurement of range may be provided for all 3 satellites and/or altitude may be provided. The time which elapses when signals are sent to terminals may be distributed e.g. by the central processor, and this may be used to synchronize the terminals to one another.

Typically, the terminal measures the round-trip time of a “transaction” aka “communication transaction” that, typically, the terminal itself initiates with the central processor through one or more satellites. In the course of such a transaction, typically, the terminal sends a transmission and the central processor typically replies with a response transmission. Each determination of range and position may be based on such a “communication transaction”.

Another possibility is to perform an initial “communication transaction” e.g. as described above. Then, to obtain the following range and position measurements, based only on transmissions from the central processor, wherein in each transmission, the processor updates the time elapsed from the terminal's initial communication (i.e., the time delay), and, if required, the position of the satellite. The number of such updates is typically limited by the clock stability of the terminal.

According to certain embodiments, navigation services are provided as a privileged service, e.g. only to customers that successfully pass an authentication criterion—say, sending a token which is confirmed to be a registered identity token.

A particular advantage of certain embodiments is discrete or private service in the sense that the terminal position can be derived only by the terminal itself.

A further particular advantage of certain embodiments is self-orienting (which, as used herein, may include navigating and/or synchronizing to a common time basis), using satellites not designed to serve as navigation satellites.

A still further particular advantage of certain embodiments is that even considerable error (say, 10-15 km) in measuring the satellite's cross-range position w.r.t. the ground facility that measures the satellite's position does not adversely affect system accuracy (e.g. accuracy in determining a terminal's position in space) in view of the negligible size of the error relative to the range of the satellite (approximately 40,000 km) . . . . It is appreciated that, generally, range error considerably affects the position accuracy, whereas cross-range error has but a minor effect on the position error.

A particular advantage of certain embodiments is that the range from the terminal to the satellite is derived easily and conveniently from the terminal↔satellite round-trip travel time, e.g. by subtracting from the total travel time, the satellite and station internal delays, and satellite↔station travel times. Since the terminal knows three ranges, whether two ranges to 2 respective satellites plus range to Earth center, or ranges to each of three satellites, the position may be derived computationally, e.g., as a closed-form, analytical solution to the intersection of three spherical envelopes, rather than using a conventional iterative approach which may require (a) finding an initial estimated position assuming the user is located on the Geoid surface, and then (b) correcting that position e.g. by introducing DEM (elevation) information.

The following terms may be construed either in accordance with any definition thereof appearing in the prior art literature or in accordance with the specification, or to include in their respective scopes, the following:

Station: this term is intended to include stations having functionalities (e.g. satellite-positioning and/or navigation control, etc.) described herein. However, station functionalities (satellite-positioning, navigation control, synchronization) may be combined in a single station. For example, navigation control/time-synchronization stations may be provided, e.g. for redundancy, and/or some satellite position-determination techniques require plural, satellite-positioning stations.

Satellite-positioning (e.g. ground control) station: this term is intended to include a station used to determine the positions of satellite (either ranging station or direction-finding station). Typically collects & processes all measurements used for satellite position determination.

Navigation control station AKA central processor: this term is intended to include a station used for navigation (and perhaps also synchronization). If accurate determination of the satellite 3D position is not performed, and only the satellite range is accurately obtained, this station is typically positioned in close proximity to the ranging station. For example, the station's distance from the ranging station may be such that using the range from the satellite to the ranging station as an estimator of the range from the satellite to the nav/synch station, leads to a nav/synch error within a use-case specific permissible range.

Time-synchronization station: this term is intended to include a station used for synchronization only. The functionalities of navigation control and time-synchronization stations may be similar. If accurate determination of the satellite 3D position is not performed, and only the satellite range is accurately obtained, this station is typically positioned in close proximity to the ranging station. For example, the station's distance from the ranging station may be such that using the range from the satellite to the ranging station as an estimator of the range from the satellite to the nav/synch station, leads to a nav/synch error within a use-case specific permissible range.

Direction Finding aka DF aka direction measurement: this term is intended to include measurement of the direction to the satellite (e.g. measurement of the [az-el] direction) e.g. from a ground station. May be expressed as two angles, e.g. azimuth and altitude. The cross range error is proportional to the DF error multiplied by the distance.

Navigation terminal: e.g. SATCOM terminal, capable of communication with at least two satellites, either simultaneously, or interchangeably.

For some techniques, an additional altimeter is provided.

While in some situations, accuracy may degrade as the terminal moves further away from the station, practically speaking, this is not insurmountable. First, this occurs only when range alone is determined, and the Direction Finding is not well constrained (i.e., the cross-range error is large). Even then, reasonable navigation is typically available within a vicinity of the ranging station which, considering the use-case, is sufficiently large. Also, in some scenarios the solution is validated e.g. if, in order to provide sufficiently accurate navigation service within a certain region of interest, a ranging station is positioned in this region.

Central Processor (used in some but not all embodiments herein): a hardware processor co-located with a transmitter/receiver, and a clock if the use-case includes time-synchronization. The transceiver is typically adequate for maintaining a concurrent communication link with several satellites.

The central processor is typically able to serve plural client terminals. The number of client terminals which may be served depends on the characteristics of the communication protocol implemented.

Time-synchronization: of a remote user who communicates with time-synch station whose position is unknown via one or more satellites whose position is also unknown. Synchronization with the station's time-base (either local or absolute) may be sought even for a single remote user (e.g. if a station is collecting time-resolved scientific measurements, which are to be incorporated, including time-synchronization, into a wider context of information).

(Single-station) range-measurement: includes estimating the range i.e. satellite's distance from the single station.

(Telescopic (aka optical) cross-range (or range and direction) measurement: includes direction measurement from the telescope's position to the satellite, and typically incorporating the range. Telescopic observations may be performed only during nighttime, when weather conditions allow observations (e.g. no clouds or fog).

Range refers to the distance between the navigation control station and the satellite.

Range measurement aka range-determination: this term is intended to include measuring the distance between the ranging station and the satellite. Because of the very large distance of the satellite from earth, the position-determination accuracy is dominated by the range error, which is minimal in the vicinity of the station.

Position determination of geostationary satellites: this term is intended to include determining, over real time, the 3D position of that geostationary satellite. It is appreciated that a 3D position relative to a ground station e.g. navigation control station, may be readily converted to an absolute position because the position of the ground station relative to the center of Earth (i.e., the absolute position of the station) is known.

Simultaneous coverage: duplex satellite communications channel, allowing transmission & reception by both parties (satellite and terminal) to be simultaneous
az: azimuth angle
el: elevation angle

Active: a terminal configured to initiate, itself, a “transaction” in order to determine range/position or to synchronize time (as opposed to conventional GNSS in which satellites repeatedly broadcast their messages, and the terminal passively receives these messages at whatever times they arrive and ‘makes do’ with this these messages to achieve whatever range/position or time synchronization goals or needs the terminal may have. The active property allows positioning to be based on range measurement e.g. using the time-of-arrival (TOA) method or measuring round-trip time, as opposed to conventional passive systems which may only rely on pseudo-range measurement using time-difference-of-arrival (TDOA) techniques. Any station which has an uplink (or duplex) channel to the satellite/s may be active, whereas stations having only a downlink channel to satellite/s are typically passive.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention thus typically includes at least the following embodiments:
Embodiment 1. A navigation system comprising:

At least one terminal configured to at least once transmit, to a communicant, e.g. via n>=1 satellite/s, a request for a reply transmission and wherein the communicant, responsively, at least once transmits a response transmission to the terminal,

Wherein the terminal measures the response transmission's time of arrival and/or round-trip time and, e.g. using a hardware processor, determines at least one of:
a round-trip time characterizing the terminal's own communication, via each of the satellite/s, with the communicant, and/or
the terminal's own range (aka distance) from each of the satellite/s

And wherein the terminal is configured, e.g. using a hardware processor, to derive self-orientation data from at least the round-trip time and from internal delay data characterizing the at least one satellite and/or the communicant.

The system is advantageous inter alia when less than three, rather than at least three, geostationary satellites are available.

Internal delays are not necessarily fixed and may fluctuate e.g. depending on satellite temperature and/or other factors, and may be made known to the terminal. The terminal can get the internal delays at a lower update rate, or can include functionality configured to estimate internal delays, e.g. based on a set of meta-data that may be refreshed a some lower update rate (e.g., the temperature and/or one or more time-derivatives of the temperature) as parameters, thereby Thus reducing transmissions at a cost of possibly lower accuracy, and/or may receive transmissions of current internal delay values, either on each of the plural occasions the terminal seeks to derive self-orientation data, for maximum accuracy, or on only some of these occasions, to partially reduce transmissions.

Similarly, regarding the positions of the 3 satellites, the terminal may operate a utility that propagates positions of the satellite, e.g., based on meta-data parameters which may be sent to the terminal from time to time e.g. Using the propagator described herein.

Measurements of the doppler shifts of the reply transmissions may by used for navigation instead of, or in addition to toa measurements.
Embodiment 2. A system according to any of the preceding embodiments wherein the communicant comprises a central station serving plural terminals.

The central station may comprise a central processor or navigation control station e.g. as described herein. In subprocess 2 described herein, either a navigation control station or a synch station may be provided. More generally, these two functionalities may or may not be provided by two separate entities e.g. 2 separate hardware processors which may or may not be co-located.
Embodiment 3. The system of any of the preceding embodiments wherein the terminal has an internal clock aka time system.
Embodiment 4. A system according to any of the preceding embodiments wherein the self-orientation data comprises self-positioning information regarding the terminal's position (aka navigation data).
Embodiment 5. The system of any of the preceding embodiments wherein the central station comprises a (stationary or mobile) ground station.
Embodiment 6. The system of any of the preceding embodiments wherein the (stationary or mobile) central station is sea-borne.
Embodiment 7. The system of any of the preceding embodiments wherein the (stationary or mobile) central station is air-borne.
Embodiment 8. The system of any of the preceding embodiments wherein the central station comprises one of the following group of airborne objects: a blimp; drone; other object hovering in the air, airplane, satellite.
Embodiment 9. A method for self-orientation of a terminal in time or space, the method comprising:

Providing a communicant e.g. central station to which a terminal sends at least one request via each of at least one respective satellites e.g. Geostationary communication satellites, and wherein the central station, responsive to the at least one request, sends at least one response to the terminal, via the at least one satellite, thereby to define a round-trip from the terminal to the communicant e.g. central station and back;

At the terminal, for each of at least one respective satellites, measuring time of arrival and/or round-trip time;
providing the terminal with an indication of internal delay aka delay times characterizing the communicant e.g. central station and each of at least one respective satellites, and data from which travel time between station and satellite can be derived, and accordingly,
determining e.g. using a hardware processor, a round-trip time including a duration of the round-trip via the at least one respective satellites; and
deriving e.g. using a hardware processor, self-orientation data including at least one of:
   synchronization data including a difference between the terminal's internal clock's current time, and a reference time system; and
   The terminal's x, y location.

Range determination (terminal vs. satellite) may include:
a. The terminal measures the elapsed timeΔt from the terminal's initial transmission to the reception of the station's reply transmission
b. The terminal derives the round-trip time (δt):

$$δ t = Δ t - \frac{‖ {X}_{sat} - {X}_{station} ‖}{c} - \frac{‖ {X}_{station} - {X}_{sat} ‖}{c} + {t}_{sat\_internal \_delay , uplink} + {t}_{sat\_internal \_delay , downlink} + {t}_{station\_internal \_delay}$$

c. The terminal computes the range to the satellite

$$( {r}_{sat\_j} ) : {r}_{sat 1} = \frac{δ t}{2} c$$

to determine its own position, the terminal estimates three or more ranges. The three or more ranges may include the terminal's own range to the center of Earth and the terminal's own ranges to at least two satellites. Or, The three or more ranges may include the terminal's ranges to at least three satellites. Then, the terminal finds a location point that best fits the three or more ranges, e.g., the intersection point of three or more spheres, the radii of which are the ranges and the centers of which are the positions of the 3 satellites (or of the 2 satellites and of the Earth's center).
Embodiment 10. The method of any of the preceding embodiments wherein the data from which the travel time can be derived includes at least one of:
   the positions of the station and of the satellite;
   the travel time
   a sum of the total travel time and the internal delays.
Embodiment 11. The method of any of the preceding embodiments wherein at least if the self-orientation data to be derived includes the terminal's x, y, location, the terminal is also provided with an indication of the position of the satellite.
Embodiment 12. The method of any of the preceding embodiments wherein the solving occurs on board the terminal and the central station does not know when the terminal receives communications from the central station.
Embodiment 13. The method of any of the preceding embodiments wherein the response sent to the terminal includes an indication of at least one of the delay times.
Embodiment 14. The method of any of the preceding embodiments wherein the response sent to the terminal includes an indication of delay times characterizing the central station and each of at least one respective satellites.
Embodiment 15. The method of any of the preceding embodiments wherein the request comprises an authentication token and/or unique identifier of the terminal.
Embodiment 16. The method of any of the preceding embodiments wherein the response comprises station internal delay, satellite internal delay, station position, and satellite position.
Embodiment 17. The method of any of the preceding embodiments wherein the at least one satellite comprises 2 satellites and wherein the self-orientation data includes the terminal's x, y location.
Embodiment 18. The method of any of the preceding embodiments wherein the at least one satellite comprises a single satellite and wherein the self-orientation data includes synchronization data.
Embodiment 19. The method of any of the preceding embodiments wherein the central station sends at least one response to the terminal only responsive to requests which the central station succeeds in authenticating.
Embodiment 20. The method of any of the preceding embodiments wherein the at least one satellite comprises a geostationary satellite, thereby to simplify computations required for the deriving.

The delay time (aka internal delay) of the central station is the time which elapses from when the central station receives a request until when the central station transmits a response.

Similarly, the delay time (aka internal delay) of the satellite is the time which elapses from when the satellite receives a transmission until when the satellite relays the transmission.

A particular advantage of embodiments herein, is that the terminal is active in that the terminal (the object which seeks to self orient) actively sends a request rather than passively accepting data from satellites. This way, the terminal can make requests when self-orientation data is required rather than at other times thereby to reduce unnecessary transmissions. Another advantage is that embodiments may operate in conjunction with satellites, such as legacy geostationary communication satellites, which do not, of their own accord, support any self-orientation, as opposed to, e.g., GNSS systems like GPS, Glonass, Galileo, or Beidou which provide their end-users with synchronization and geo-spatial positioning worldwide. The terminal also generates self-orientation data without suffering from known drawbacks of inertial systems which are known alternatives to GNSS systems. Another advantage is that the terminal herein can function in conjunction with only 2 satellites if the terminal requires x, y location data, with or without synchronization, and can function in conjunction with but a single satellite if the terminal requires only synchronization data and does not require x, y location data.
Embodiment 21. The system of any of the preceding embodiments wherein the at least one satellites, whose communication services are used by the terminal, comprise one satellite or two satellites or three satellites.
Embodiment 22. The system of any of the preceding embodiments wherein the self-positioning information comprises a 3d position x, y, z.
Embodiment 23. A system according to any of the preceding embodiments wherein the self-orientation data comprises synchronization data including a difference between the terminal's internal clock's current time, and a reference time system.
Embodiment 24. A system according to any of the preceding embodiments wherein the at least one terminal is configured to provide at least two “terminal range” measurements including at least one measurement of the terminal's own range (aka distance) from each of at least two satellites e.g. Geostationary communication satellites.
Embodiment 25. A system according to any of the preceding embodiments wherein the response transmission includes satellite location information indicative of location of the at least one satellites.
Embodiment 26. The system of any of the preceding embodiments wherein the response transmission includes internal delay data characterizing the at least one satellite and/or the central station.
Embodiment 27. The system of any of the preceding embodiments wherein the self-orientation data aka terminal orientation data comprises x, y data which enables the terminal to perform auto-positioning.
Embodiment 28. The system of any of the preceding embodiments wherein the self-orientation data comprises data which enables the terminal to synchronize its own internal clock to a time standard external to the terminal.

The data sent from station to terminal may include, for use-cases in which the self-orientation data includes navigation data, the position of the (>=2) satellites, and for each satellite, the time elapsed from the reception of the terminal's transmission by the satellites, to the relay from the satellite to the terminal of the station's reply transmission, or information from which it is possible to derive this time duration.

The data sent from station to terminal may include, for use-cases in which the self-orientation data includes synchronization data, a time stamp indicative of the station's time at the midpoint of the elapsed time between the station's receive and transmit times, which corresponds to the time at the midpoint of the elapsed time between terminal's transmission and the terminal's reception of the station's reply transmission, thereby to provide synchronization with only a single data item being sent from the station to the terminal and without requiring additional knowledge, e.g. of the satellite position and internal delays.

If the satellite internal delay is not the same both ways (e.g. on both legs of the round-trip, both to and from satellite), the time stamp provided is shifted accordingly. An alternative is sending the information indicative of the station & satellite internal delays, and a time stamp indicative of the station's time for some other well-defined event, e.g. the satellite's receive or transmit time, or the station's receive or transmit times.
Embodiment 29. The system of any of the preceding embodiments wherein the positions of the at least 2 satellites are derived for use by the system, e.g. by triangulation from plural known locations.
Embodiment 30. The system of any of the preceding embodiments wherein the communicant serves more than 1 terminal.
Embodiment 31. The system of any of the preceding embodiments wherein the terminal at least once transmits “location measurement” requests to the ground station which, responsively, sends to the terminal, at least once, the position of the (>=2) satellites, and information from which it is possible to derive the time elapsed from the reception of the terminal's transmission by each individual satellite from among the at least one satellites, to the relay from the individual satellite to the terminal of the station's reply transmission.
Embodiment 32. The system of any of the preceding embodiments wherein the central station transmits plural response transmissions responsive to a single request by the terminal.
Embodiment 33. The system of any of the preceding embodiments wherein the satellite/s includes at least first and second satellites, and at least the first satellite provides both an uplink and a downlink, and at least the second satellite provides a single communication link, either downlink or uplink but not both, totaling at least 2 links provided by the at least first and second satellites.
Embodiment 34. The system of any of the preceding embodiments wherein the satellite/s includes at least 3 satellites, each of which provides a single (either downlink or uplink but not both) communication link, totalling at least 3 links provided by the at least 3 satellites respectively and wherein the at least 3 links include at least one uplink and at least one downlink.

Typically, as described in the embodiment of FIG. 7, a navigating terminal establishes two or more different communication links with the navigation control station, each link via two satellites, one of which provides an uplink and the other of which provides a downlink.
Embodiment 35. The system of any of the preceding embodiments wherein the terminal comprises a moving terminal and wherein at least 2 transactions, each including at least one request and response, are used each time the terminal derives self-orientation data.
Embodiment 36. The system of any of the preceding embodiments wherein the self orientation data of the moving terminal is derived from plural replies provided to a single request.
Embodiment 37. The system of any of the preceding embodiments wherein barometric altitude is known and wherein the terminal uses the altitude to determine a third range, from the center of Earth, and then determines its own location accordingly. This is advantageous at least because it requires only 2 geostationary satellites.
Embodiment 38. The system of any of the preceding embodiments and wherein the 3D position of the terminal is generated by geolocation based e.g. on TOA (time of arrival) measurements generated by the terminal's internal clock.
Embodiment 39. The system of any of the preceding embodiments wherein the terminal has an internal clock and wherein the self-positioning information comprises a time-stamp, generated by the terminal's internal clock, indicating a time t at which the terminal occupied coordinates x, y, z in space.
Embodiment 40. The system of any of the preceding embodiments wherein the terminal has an internal clock and wherein the self-positioning information comprises a time-stamp, generated by the terminal's internal clock, which is used by the terminal in synchronizing its own internal clock to a time standard external to the terminal, and wherein the synchronization includes the terminal determining the time of its own internal clock which corresponds to at least one time-stamp sent by the communicant.

The time stamp sent by the central station to the terminal is typically indicative of the station's time at a midpoint of the round-trip time elapsing between the terminal's transmission of the request and the terminal's reception of the station's reply transmission, thereby to provide synchronization with only a single data item being sent from the station to the terminal and without requiring additional knowledge, e.g. of the satellite position and internal delays.
Embodiment 41. The system of any of the preceding embodiments wherein the time standard external to the terminal comprises a Time standard, e.g., Coordinated Universal Time (UTC), GMT, TAI).
Embodiment 42. The system of any of the preceding embodiments wherein the (stationary or mobile) central station is space-borne.
Embodiment 43. The method of any of the preceding embodiments wherein at least if the self-orientation data to be derived includes the synchronization data, the terminal is also provided with an indication of time or time-stamp, of a defined event.
Embodiment 44. The method of any of the preceding embodiments wherein the request also indicates which type of service the terminal is requesting e.g. navigation only, synchronization only, both.
Embodiment 45. The method of any of the preceding embodiments wherein the request also indicates that multiple replies are requested including number and/or repetition rate of the multiple replies.
Embodiment 46. A system according to any of the preceding embodiments wherein only the terminal computes and knows its own position, and the communicant does not compute or know the terminal's own position.
Embodiment 47. A system according to any of the preceding embodiments wherein the communicant comprises a satellite that relays the terminal's transmission back to the terminal, and there is no other satellite involved in the communication loop.

It is appreciated that in this NSIL embodiment, the communication loop is typically terminal↔communucation_geo_satellite only.
Embodiment 48. A computer program product, comprising a non-transitory tangible computer readable medium having computer readable program code embodied therein, the computer readable program code adapted to be executed to implement a method for self-orientation of a terminal in time or space, wherein at the terminal, for each of at least one respective satellites, time of arrival and/or round-trip time is measured, wherein a communicant is provided e.g. central station to which a terminal sends at least one request via each of at least one respective satellites e.g. Geostationary communication satellites, and wherein the central station, responsive to the at least one request, sends at least one response to the terminal, via the at least one satellite, thereby to define a round-trip from the terminal to the communicant e.g. central station and back, and wherein the method comprises:

According to an indication of internal delay aka delay times characterizing the communicant e.g. central station and each of at least one respective satellites, and data from which travel time between station and satellite can be derived, with which the terminal is provided:
determining a round-trip time including a duration of the round-trip via the at least one respective satellites; and
deriving self-orientation data including at least one of:
   synchronization data including a difference between the terminal's internal clock's current time, and a reference time system; and
The terminal's x, y location.
Embodiment 49. The method of any of the preceding embodiments wherein the at least one satellite comprises a least 3 satellites and wherein the self-orientation data includes the terminal's x, y, z location.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g. BLE) or wired (e.g. USB)), or a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program, such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein, includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1 illustrates a system for range-determination by a single ground station.

FIG. 2 illustrates a system for position-determination by single-station range measurement telescopic cross-range measurement.

FIG. 3 illustrates a system for position-determination combining independent range measurements of three separated ground stations.

FIG. 4 illustrates a system for position-determination combining range measurements of one transceiving, and two receiving ground stations.

FIG. 5 illustrates a terminal connecting to a navigation control station via two satellites.

FIG. 6 illustrates a terminal connecting to a time-synchronization control station via a satellite.

FIG. 7 illustrates a terminal connecting to a navigation control station via three satellites.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein, may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line, which is of any type or level or amount or category of volatility, differentiation, mutability, accessibility, addressability, capacity, performance and energy use, and which is based on any suitable technologies such as semiconductors, magnetic, optical, paper, and others.

### DETAILED DESCRIPTION OF CERTAIN EMBODIMENTS

Certain embodiments include a positioning system that is based on (at least two) geostationary communication satellites. The system allows positioning/navigation within regions that are covered by both an uplink and a downlink beam of at least one of the satellites, and either the uplink beam or the downlink beam of each of the other satellites used for positioning.

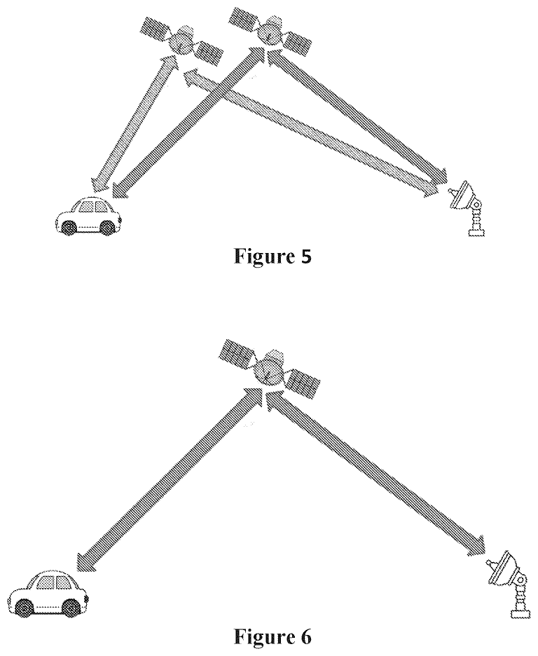

To overview, one process provided herein includes one or both of the following 2 stages aka sub-processes:
Stage (aka Sub-process) 1: Accurate determination of (at least two) geostationary satellites' locations (either 3-axis position, or range aka options A, B respectively)
Stage (aka Sub-process) 2: Self-positioning/navigation and/or time-synchronization including communicating with a ground control station via the (at least two) geostationary communication satellites e.g. as shown in FIG. 5.

Throughout this document, flows may include all or any subset of the described operations, suitably ordered e.g. as presented by way of example.

### Stage 1

Stage 1 typically comprises operations I, ii, iii.

Of the 3 operations in Stage 1, operations ii, iii are typically the same for options A, B. Operation I of Stage 1 depends on which location data is being determined:
3-axis position option aka Option A: the full 3-axis locations of the geostationary satellites involved, or
Range option aka Option B: the distance between these satellites and a ground station.

There are 3 methods for performing stage 1's operation I if the 3-axis position option aka Option A is used, as shown in FIGS. 2-4 respectively. The first (FIG. 2) uses a telescope, the second (FIG. 3) uses independent range measurements from 3 stations, and the third (FIG. 4) uses a single (“first”) station which generates range measurements, and 2 additional stations, which are passive and time-synchronized to the first. There are 2 methods for performing stage 1's operation I if the Range option aka Option B is used. One method uses a single ground station, the other uses 2 ground stations.

### Stage 2

There are 2 methods for performing stage 2, assuming both self-position and time-synchronization are sought. As shown in FIG. 6, there is a 3^{rd} method for performing stage 2, for use-cases in which self-position is not required, and only time-synchronization is sought.

It is appreciated that positioning may be based on determining range to two or more satellites. Range determination to a first satellite may include measuring the round-trip time of a “communication transaction” with a central processor through the satellite (i.e. satellite1 duplex: terminal→satellite1→central_processor→satellite1→terminal). Range to a second satellite may be derived by measuring the round-trip time of “communication transaction” with the central processor through the first satellite and the second satellite (i.e., satellite2 DL only: terminal→satellite1→central_processor→satellite2→terminal, or satellite2 UL only: terminal→satellite2→central_processor→satellite1→terminal). For UL/DL “transactions”, the distance between the terminal and satellite1 typically must be known and may be determined by the duplex “transaction” with satellite1.

Simultaneous coverage of both uplink & downlink beams of at least one of the satellites, and either the uplink beam or the downlink beam of each of the other satellites used for positioning, is required for the active ranging measurements approach described herein.

The bandwidth of communication satellites is a scarce and expensive resource, and embodiments herein recognize this and advantageously use 2 or 3 or even 1 satellite, not 4, e.g. by having an active rather than passive navigation terminal.

Passive pseudo-ranging measurements typically entail coverage by downlink beams only. The passive ranging approach, which is used, e.g. in conventional GNSS systems, may conveniently be incorporated into the system proposed here, e.g. as an alternative/backup positioning method.

Alternatively or in addition, the system may provide time-synchronization, based on at least one geostationary satellite and available within regions that are covered by both an uplink and a downlink beam of the satellite.

The system comprises navigation terminal(s), (at least two) geostationary communication satellites, (at least one) ground stations used to accurately determine the ranges to, or the positions of the satellites, and a navigation control station.

The process comprises two sub-processes (aka stages):
Sub-process (aka stage) 1: obtaining satellite location data, e.g., from the SATCOM service operator, or, if required for higher-accuracy positioning, generating more accurate satellite location data, e.g. by accurately determining either:
(satellite position option—) Option A: the full 3-dimensional locations of the geostationary satellites involved, or
(satellite range option—) Option B: the distance between these satellites and a ranging station (and by that, also the navigation-control station). In this case, raw determination of the satellite's direction (e.g., azimuth+elevation) is required. Typically, such information is freely available and accessible e.g., from the SATCOM service provider.

It is appreciated that both options A and B can be omitted e.g. because coarse satellite position may be obtained even from the SATCOM service operator. This might lead to coarse location determination which may suffice for some use cases. If more accurate positioning is required, option A and/or B may be implemented.

It is also appreciated that the 2 methods below for subprocess 2 are orthogonal to the above options a, b, e.g. any of the methods for performing Subprocess 1 may be combined with any of the methods for performing Subprocess 2.

The output of option b (distance between satellites and ground station) is useful inter alia because useful positioning service (in regions in the vicinity of the station) may be provided, based on only one ranging station (and not three ranging stations, or a ranging station+a DF station).

This information is useful for high-accuracy positioning/navigation. Accurate determination of the satellites position is typically required only when this information is not available (this is the general case). One alternative approach for obtaining accurate satellite position is equipping the satellites (prior to their launch, of course) with self-positioning apparatus (such as, e.g. a suitable GNSS receiver). Currently, most, if not all GEO communication satellites are not equipped with such apparatus.
Subprocess (aka stage) 2: Self-positioning/navigation and/or time-synchronization by communicating with the navigation control station via (at least two) geostationary communication satellites (or by communicating with the time-synchronization station via at least one geostationary communication satellite). FIG. 5 shows a terminal connecting to a navigation control station via plural (e.g. two) satellites.

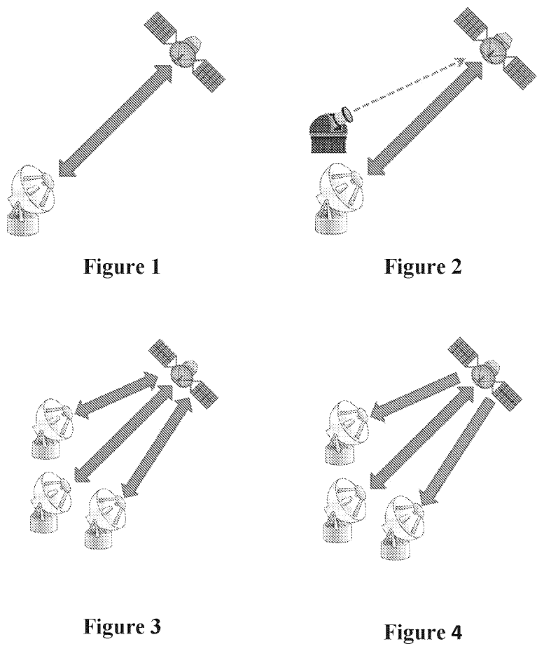

Turning first to the second option for how to perform stage 1, a 3-operation method for performing option b of sub-process 1 is now described in detail. The method typically includes all or any subset of the following operations, suitably ordered e.g. as follows:
OPERATION B1: Accurate range determination of geostationary satellites Information pertaining to the accurate instantaneous position of a geostationary satellite is obtained by applying any of the 4 measurement methods described below with reference to FIGS. 1-4 respectively.
OPERATION B2: combining measurements and observations with a suitable computational model of the orbit to yield a more accurate propagator is known in the art in this field, e.g. for GNSS satellites as described e.g. in the Wikipedia entry for simplified perturbations models.

Thus, these measurements are combined with previous measurements, as well as with information regarding the forces acting on the satellites, and with publicly available information pertaining to the coarse position of the satellite to yield an accurate propagator (e.g. analytic expression describing the satellite orbit, from which the satellite position over time may be derived). Typically, the measurements of B1 are accumulated over time. Any suitable e.g. publicly available computational model may be employed e.g. any of the SGP models which include orbital equations as well as the coefficients of the equations (e.g. Earth gravitational three-dimensional field). The scope of this invention is not however limited to publicly available models since other models may be developed for specific requirements of a given use-case. Given an initial satellite state (position, velocity, acceleration, . . . ), these models provide an estimation of the satellite state over time. Actual measurements (past and present, of B1) may be used as constraints on the model at the time of the measurements, allowing to tweak the model to provide even more accurate results.
Operations B2, B3 yield more accurate (range, and/or cross range) position estimation, and provide estimated satellite positions in between measurements, however, these operations are optional.
OPERATION B3: The up-to-date propagator is transferred to the navigation control station.

It is appreciated that the propagator, whose computational model provides the satellite state as a function of time, may be provided as a computer program, where the input is the time, and the output is the satellite state. Implementations are available online e.g. code implementations of SGP-4.

1^{st} Possible Method for Performing Operation B1:

Range-determination by a single ground station (e.g. as in FIG. 1).
i. A ground transceiver station at a well determined position sends a signal to the satellite.
ii. The satellite receives the signal and transmits it back to the station.
iii. The station measures the two-way travel-time.
iv. The range is estimated by eliminating the pre-determined internal receive-transmit delay of the satellite.

The communication may be carried through either the command/telemetry channel of the satellite, or through its commercial transponders.

Accurate satellite range measurements using this method allow accurate navigation in regions close to e.g. within a few hundreds of kilometers from, the range-measurement station. Navigation accuracy degrades with increasing distance from the station.

2^{nd} Possible Method for Performing Operation B1:

Range determinations from two close ground stations, identical to the description of the 1^{st} possible method above, are combined (e.g., averaged) to yield a weighted range estimate. Weights may for example be assigned according to the estimated quality of the results (e.g. by the signal-to-noise ratio)

Returning now to the first option for how to perform stage 1, a 3-operation method for performing option a of sub-process 1 is now described in detail. All or any subset of the following operations may be provided, in any suitable order e.g. as follows:
OPERATION A1: Accurate position determination of geostationary satellites

Information pertaining to the accurate instantaneous position of a geostationary satellite is obtained by applying one of the measurement methods described below.
OPERATION A2: same as operation B2.

Operations A2, A3 are optional, for yielding more accurate (both range, and cross range) position estimation, and/or providing estimated satellite positions in between measurements.
OPERATION A3: Same as B3.

Any suitable method may be employed to perform Operation A1. FIGS. 2-4 show three methods of satellite position measurements which are now described in detail.

Single-station range-measurements described in 1^{st} possible method for performing operation al (e.g. as shown in FIG. 2) may be performed; the output typically includes the 3D position of the satellite. All or any subset of the following operations may be provided, suitably ordered e.g. as follows:
i. optical telescope at well-defined position (same geographic location as range-determination station, or different site), generates time-resolved images of satellite.
ii. Determine the direction (the [az-el]) from the telescope's position to the satellite) by precisely measuring the satellite's position on the celestial sphere in the telescope's images (position on the celestial sphere is measured by applying astrometric techniques on telescopic images).
iii. The range and the <az-el> direction fully describe the position of the satellite e.g. as described in
   2015 Weiss et al.—“GEO Satellites Tracking Using Optical Observations” which describes that “to better measure and model the position of geosynchronous satellites in space, we developed an autonomous robotic system to optically observe the satellite and determine its position on the sky. The satellite is imaged on a CCD camera through a telescope that is positioned in a closed building. The images are reduced automatically and the angular position of the satellite is found. We use a novel method to find the satellite position on the image which involves several exposures on the same image and a new algorithm to determine the satellite angular position relative to the stars in the image. The angular position is then used through a detailed model to better determine the position of the satellite and to propagate its trajectory to future times with a good accuracy. The position is found to an accuracy of about 0.5 arcsec (less than 100 meters). Combining the angular position with radar range measurements of the position of the satellite can improve its known position.”

An advantage of combined range and direction measurements is that (as for any method yielding full 3-dimensional location information) accurate, full 3-dimensional (3-D) location information of the satellite are provided, and consequently, navigation accuracy does not degrade with increasing distance from the station. 2^{nd} possible method for performing OPERATION A1 (e.g. as shown in FIG. 3): Position determination by combining independent range measurements (as described in the 1^{st} possible method for performing Operation B1) of three separated ground stations (FIG. 3 e.g.).
i. Three separated ground stations perform range measurements as described in method (1); and/or
ii. to obtain the 3-D location of the satellite the three range measurements may be combined; it is appreciated that geolocation based e.g. on TOA (time of arrival) measurements from plural positions is known in the art in this field, as well as in the field of geolocation e.g. as described in Statistical Theory of Passive Location Systems, 1984, D. Torrieri, available online via Semantic Scholar (DOI:10.1109/TAES.1984.310439Corpus ID: 8983806; IEEE Transactions on Aerospace and Electronic Systems).

Satellite location accuracy improves when the distance between the stations increases.

Highest navigation accuracy is achieved in the region between the stations. Navigation accuracy then degrades with increasing distance from the stations to an extent which depends on the satellites' location accuracy. an anisotropic location error is the typical case. The accuracy of navigation that is based on sources with known positions having anisotropic location error (in our case, the satellites) typically varies with location.

3^{rd} possible method for performing OPERATION A1 (e.g. as shown in FIG. 4):

Position determination by combining range measurements of at least three stations: at least one transceiving ground station, and additional ground stations that are either only receiving, or only transmitting. The stations are typically positioned in separate or non-co-located or distant locations (e.g. as per FIG. 4). All or any subset of the following operations may be provided, suitably ordered e.g. as follows:
i. The time base of all receiving-only and transmitting-only stations is synchronized with a transceiving station
ii. Each transceiving station performs range measurements in a manner e.g. as described in 1^{st} possible method for performing OPERATION B1.
iii. Each transmitting station (both the transceiving and transmitting-only ones) incorporates a transmitted time-stamp or time-stamp representing the transmission time in the transmitted signal
iv. Each passive (i.e., downlink-only) station:
   a. received the signal from the synchronized transceiving station that is returned from the satellite.
   b. incorporates its location, the location of the synchronized station, the difference between the signal reception time and the signal transmission time, and the internal receive-transmit delay of the satellite to estimate the range to the satellite
v. For each active (i.e., uplink-only) station:
   a. The synchronized transceiving station receives the signal from the transmitting station that is returned from the satellite. It then incorporates its location, the location of the transmitting-only station, the difference between the signal reception time and the signal transmission time, and the internal receive-transmit delay of the satellite to estimate the range between the transmitting-only station and the satellite.
vi. The (at least three) range estimates are combined to obtain the 3-D location of the satellite e.g. as described herein in the context of position determination by combining independent range measurements.

Satellite location accuracy improves when the distance between the stations increases.

Highest navigation accuracy may be achieved in the region between the stations.

Navigation accuracy would degrade with increasing distance from the stations (the measure of degradation depends on the satellites' location accuracy).

Three methods for performing subprocess 2 (self-positioning/navigation & time-synchronization by communication with the navigation control station via (at least two) satellites) are now described in detail. All or any subset of the following operations may be provided, in any suitable order e.g. as follows. It is appreciated for example, that certain operations below may be omitted, if only navigation is required for a given use-case, and the use-case does not require time-synchronization. 1^{st} possible method for performing subprocess 2 (aka option 2a):
a. The navigation terminal establishes a number of communication links with the navigation control station via a number of satellites (one per satellites, see e.g. FIG. 5)
b. Through each link, the terminal transmits a signal that may include an identification token of the terminal encoded into it.
c. In each link, upon receiving a signal from a terminal, the navigation control station may compare the terminal identification token to a whitelist in order to determine if the terminal is to be served.
d. The navigation control station then transmits a signal to the terminal through the same satellite. Encoded into the transmission i, at least, is all or any subset of the following information:
   The navigation control station location (X_{gs})
   The satellite location (Xₛₐₜ)
   The satellite internal receive-transmit delay (tₛₐₜ)
   The navigation control station internal receive-transmit delay (t_{gs})
   The station may transmit as few as two parameters, <Xₛₐₜ> and either the following combination of parameters:

$$< 2 \frac{‖ {X}_{g s} - {X}_{s a t} ‖}{c} + 2 {t}_{sat} + {t}_{gs} > ,$$

where c is the speed of light, or any arrangement of the parameters within this expression, that allows its reconstruction. The transmission may also include:
A time stamp representing the transmitted time-stamp or transmission time of the return signal
e. The terminal receives the return signal. By subtracting the terminal's signal transmit time from the return signal reception time, the terminal determines the total round-trip time. Then, by subtracting the given combination of parameters, the terminal can readily determine the range to the satellite.
f. If two satellites are used for navigation, the terminal uses the positions of the satellites and the estimated ranges to the satellites, and a barometric altitude measurement of the terminal to determine its 2-dimensional horizontal position (<X, Y> position), e.g., by finding the intersection point of three spheres, the centers of which are Earth's center, and the positions of the two satellites, respectively, and the radii of which are the distance the Earth's center (derived from the terminal's barometric altitude), and the ranges to the two satellites, respectively. The terminal may then further use a transmitted time-stamp and its altitude & <X, Y> position to synchronize it's time base. Combining ranges from three known locations (in this case, the two satellites and the Earth's center) is known in the art of geolocation. For example, one approach is to find the intersection of three spheres, the centers of which are at known positions and the radii of which are the three ranges.
g. If more than two satellites are used for navigation, the terminal may combine the positions and the estimated ranges to the satellites to determine its 3-D (<X, Y, Z>) position, and/or may combine a transmitted time-stamp and the range to the satellite, to synchronize its time base. Identifying an object's 3D position by combining the object's ranges to plural known locations is known in the art of geolocation. The minimal number of ranges that are used is typically 3; methods may be the same when using more locations.

It is appreciated that the system herein typically utilizes stations' and satellites' internal delays. Therefore, typically, the station may time its own signal receptions as well as transmissions, and may compute the difference between the two to yield the station's internal delay. Any suitable method may be employed to derive the satellite's internal delay, e.g. pre-launch calibration, and/or independently measuring round-trip time and satellite range. As for satellites' internal delays, these data may be available to end-users from satellite operators. Alternatively or in addition, satellites' internal delays may be measured from the ground e.g. by independently measuring round-trip time and satellite range. Alternatively or in addition, satellites' internal delays may be estimated by the publicly-available specification of the satellite's communication payload. Alternatively or in addition, satellites' internal delays may be estimated based on professional experience, yielding valid locations, yet with greater error it is appreciated that most communication satellites include bent-pipe relays having similar design from which the internal delay may be estimated.

Any suitable method may be employed for navigation (e.g. for determining a moving terminal's e.g. vehicle's horizontal (<X, Y>) position) based on two satellites. Typically, the terminal determines the terminal's horizontal (<X, Y>) position by combining ranges from three known locations:
Locations 1, 2: the two satellites' positions aka locations—using estimated ranges to the satellites, and
Location 3: location of the Earth's center relative to the terminal (yielded by the terminal's barometric altitude measurement).

It is appreciated that combining ranges from three known locations (of the two satellites and of the Earth's center) is known in the art of geolocation e.g. by finding an intersection of three spheres, centered in the 3 known locations and whose radii are the three ranges respectively.

Typically, since there are two points of intersection between the three spheres for a user located in the northern hemisphere, the second solution will be in the southern hemisphere. For users near the equator, possible ambiguity is trivially resolved by north/south movement.

Then, a transmitted time-stamp and the <X, Y> position may be used to synchronize the terminal's time base.

Typically, once the <X, Y> position is determined, absolute time-synchronization may be performed e.g. as described herein.

### 2^{nd} Possible Method for Performing Subprocess 2 Aka Option 2b:

[similar to the method used by the Beidou-1 navigation system]
a. The navigation control station sends inquiry signals to the users via (at least two) satellites.
b. The navigation terminal receives the signal from one satellite and sends a responding signal back to the station via (at least two) satellites. The terminal encodes, in the return signal, all or any subset of the following information:
   The terminal internal receive-transmit delay.
   The terminal barometric altitude (required only if exactly two satellites are used for navigation).
   Time-stamp representing the transmitted time-stamp or transmission time of the return signal (optional).
c. The navigation control station receives the responding signals sent by the navigation terminal via the satellites
d. If two satellites are used for navigation, the station typically determines the terminal's 2D horizontal (<X, Y>) position by combining all or any subset of the following known parameters: the station's position, the satellites positions, the round-trip time, the internal delays, and the terminal's barometric altitude measurement.
   Typically, combining includes estimating the ranges to the satellites (which are at known positions) and combining those ranges e.g. using conventional geolocation methods. For example, typically, for a given satellite the round-trip time minus the internal delays is equal to the round-trip distance divided by c, which is 2×[(user-to-satellite distance)+(satellite-to-station distance)].
   The station-to-satellite distance may be determined by finding the distance between the positions of the satellite and of the station.
   The user-to-satellite distance may be computed by subtracting the station-to-satellite distance from the round-trip distance.
   Then, finding the location of a point based on the point's known distances to three points of known location (i.e., combining ranges to a number of known locations), is equivalent to solving the geometrical task of finding intersection points of three spherical envelopes, having centers whose locations are known, and known radii.
e. If more than two satellites are used for navigation, the terminal combines (e.g. as described in option 2a, section above) the positions of the station and the satellites, the round-trip times, and the internal delays, to determine the terminal's 3-D (<X, Y, Z>) position.

If the terminal sent a time-stamp, the station may further estimate the time-synchronization error of the terminal.

The station may transmit the navigation and/or clock information back to the terminal.

Certain use-cases for subprocess2 may include only self-positioning, or only navigating, with no need to do time-synchronization. Other use-cases may not need to do self-positioning, or navigating, but may do time-synchronization (of a remote user who communicates with time-synch station whose position is unknown via one or more satellites whose position is also unknown). Still other use-cases may include self-positioning, navigating, and time-synchronization. Time-synchronization may be used to synchronize plural remote users to one another.

### EXAMPLES

navigation only: if position is important, but time is not. For example, a mobile vehicle (ground/airborne/sea-borne) that is to displace from some starting point to a desired end point.
time-synchronization only: e.g. when a group, array or cluster of (perhaps non-mobile)−<objects> operate in concert, e.g., a network of distant radio-telescopes, the observations of which are to be combined into a single interferometric image.
both navigation and time-synchronization: e.g. a group or swarm of drones performing in concert some coordinated task, such as delivery of heavy parts all to a single location, where, due to weight-bearing limitations, plural drones are required to deliver all parts ordered.

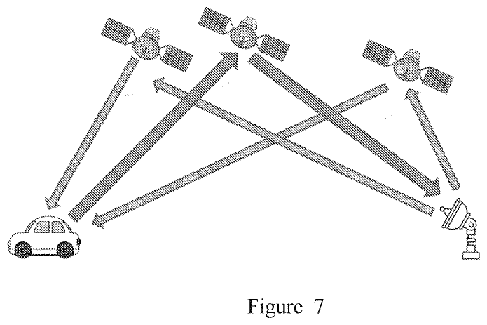

Another possible method for navigation (subprocess 2) aka aka option 2c, is now described in detail, referring to FIG. 7 merely by way of example.

When using at least 3 satellites, all of which provide either downlink or uplink, but not both, and at least one satellite provides downlink, and at least one other satellite provides uplink.

The navigating terminal typically establishes at least two different communication links with the navigation control station, each one via two satellites (one providing uplink and the other providing downlink, e.g., terminal→satellite1→navigation control station→satellite2→terminal).

In each link, the terminal typically initiates a “transaction” with the navigation control station, e.g. as described in the above options. The navigation control station typically replies with a transmission that includes information on the positions of the two satellites, as well as information that allows the time elapsed between the reception of the terminal's signal to be computed by satellite1 and the transmission of the reply signal from satellite2 to the terminal (hereafter t_{s1-gs-s2}, which is equal to

$$\frac{‖ {X}_{g s} - {X}_{s a t 1} ‖}{c} + \frac{‖ {X}_{g s} - {X}_{s a t 2} ‖}{c} + {t}_{sat 1} + {t}_{sat 2} + {t}_{g s} ) .$$

Here, tₛₐₜ₁, tₛₐₜ₂, t_{gs} are the internal delays of satellite1, satellite2, and of the navigation control station, respectively.

$$\frac{‖ {X}_{g s} - {X}_{s a t 1} ‖}{c} , \frac{‖ {X}_{g s} - {X}_{s a t} ‖}{c}$$

are the signal travel times satellite1→navigation control station, and navigation control station→satellite2, respectively, and c is the speed of light.

The terminal typically measures the transaction's round-trip time, subtracts t_{s1-gs-s2}, and multiplies the result by c to derive the sum of the ranges between the satellites and the terminal (hereafter, Rₛ₁₋ₜₑₐₘ₋ₛ₂): ∥Xₜₑᵣₘ−Xₛₐₜ₁∥+∥Xₜₑᵣₘ−Xₛₐₜ₂∥.

Obtaining at least two measurements of Rₛᵢ₋ₜₑᵣₘ₋ₛⱼ, (where i, j, are the indexes of the satellites), and of the terminal's barometric altitude (or at least three such measurements), the terminal may estimate its position, e.g., by finding the intersection points of two ellipsoid surfaces, whose foci are <tᵢ, tⱼ>, and whose surface is defined by Rₛᵢ₋ₜₑᵣₘ₋ₛⱼ, with a sphere whose center is the center of Earth, and whose radius is the distance to Earth's center. Or, the intersection of at least three such ellipsoidal surfaces may be found.

Stage 2 aka subprocess 2 may require time-synchronization only, provided by communication with the synchronization control station via at least one satellite.

A method for time-synchronization of a remote user, by communicating with a time-synchronization station via at least one satellite, is now described; for example FIG. 6 shows a terminal connecting to a time-synchronization control station via a satellite. The method advantageously requires no knowledge about the position of the satellite, nor of the position of the time-synchronization station. Given accurate estimations of the internal receive-transmit delay times of the satellite and the station, the methods may provide high-accuracy, absolute time synchronization, anywhere within regions that are covered by both an uplink and a downlink beam of the satellite. For a fixed (non-mobile) user terminal, a single “transaction” is typically sufficient for synchronization. If the terminal moves in a straight line at a constant speed, two transactions are typically sufficient for synchronization. Typically, variation of the round trip time between consecutive transactions is indicative of the terminal's translation between the two transactions. Monitoring a series of transactions allows the re-creation or reconstruction of the terminal's movement, and improves estimation of the terminal's location.

A synchronization transaction typically comprises all or any subset of the following operations, suitably ordered e.g. as follows:
a. The user terminal transmits a signal to the time-synchronization station via a geostationary satellite. The transmission may include an identification token of the terminal encoded into it.
b. Upon receiving the signal from a user terminal, the time-synchronization station may compare the terminal identification token to a whitelist in order to determine if the terminal is to be served.
c. The time-synchronization station transmits a return signal to the terminal through the same satellite. Encoded into the signal is all or any subset of the following information:
   The satellite internal receive-transmit delay
   The time-synchronization station receive-transmit delay time
d. A time stamp representing the transmitted time-stamp or transmission time of the return signal (either the absolute time or the time measured by the station clock). The user terminal receives the station's return signal.
e. The terminal obtains the total gross round-trip time by subtracting the transmission time of the transmitted message from reception time of the return message, and the net round-trip time by subtracting the station internal delay and twice the satellite internal delay from the gross round-trip time. Synchronization is performed by adjusting the terminal clock so that the time of the round-trip midpoint plus the station internal delay is set to the transmitted time-stamp or time-stamp sent by the station (representing the transmission time of the return message).

It is appreciated that many variations of the embodiments herein are possible. For example, the implementation may be such as to obviate any need for communication with the navigation control station. Typically, for navigation of the terminal information about the location of at least two satellites, and in addition, information about their internal delay times, will suffice. The satellites are typically required to have (UL+DL) communication to the terminal's possible location in space. Typically, e.g. as described herein, the terminal estimates its location by measuring the range of satellites. In this case, however, the range may be estimated by measuring the round-trip time of a signal from the terminal via satellite, back to the terminal (while reducing the internal residence time on the satellite). The terminal may receive locations and internal delays of satellites in any suitable manner e.g. broadcast communication (via satellite or direct), which may be continuous. Or, if the terminal computes a satellite propagator, the satellite orbit parameters may be updated from time to time e.g. periodically. For synchronization of the terminal, information about the internal delay of a single satellite, which communicates (UL+DL) with the terminal's possible location/s in space, is sufficient. A sync signal from some external source (“sync station”) is transmitted e.g. broadcast via the satellite. Relative navigation of a group or set of terminals that are only a few tens of km or less distant from one another, typically does not require the exact location of the satellites, and knowledge (including estimates) of their internal delays are sufficient. For synchronization of a group of terminals only a few tens of km or less distant from one another using a common time base, the internal delay of a single satellite is sufficient. One of the terminals can estimate a range and send a synchronization signal to the other terminals.

Alternatively or in addition, variations include that any of the following combinations of stations may be provided:
A single transceiving ground station
At least one transceiving ground station+at least one telescope station
As least two telescope stations
Three or more transceiving ground stations
At least three stations, one of which is a transceiving ground station and the other stations, some or all of which may be reception-only (only downlink), or transmission-only (only uplink), or transceiving (both uplink and downlink).

Alternatively or in addition, the control stations (navigation control, time-synch), and/or stations performing satellite positioning functionality (ranging, DF, . . . ) may be on the ground or sea-borne or air-borne, and may be either on the move or fixed. It is appreciated that all of these stations' instantaneous positions are typically accurately known to the system e.g. to the terminal.

Alternatively or in addition, variations include that any of the following methods may be used for obtaining satellite position information:
1. Range-only from a single site (station)
   a. Radar-based range determination
   b. Laser-based range determination
   c. Communication-based range determination (e.g. the method described herein which includes measuring a transmission round-trip time)
   d. Full (3D)-location by measurements from a two (co-located or separated) sites (stations) range measurement (one of the methods above+optical DF
   e. 3D-location by measurements from a two separated or non-co-located sites (stations) e.g. with 2× optical DF
   f. 3D-location by measurements from three separated or non-co-located sites (stations). 3× range measurement (e.g. one of the methods above). If the stations are close, the cross-range may be badly constrained, somewhat like the range-only measurement embodiment. The 3 stations may for example be:
      i. three transceiving stations
      ii. three time-synchronized stations: one transceiving+two either transmitting or receiving
      iii. three receiver/transmitter stations
2. Self-location using an on-board GNSS receiver.

Alternatively, any other suitable method known in the art for obtaining information re satellite position may be employed. Typically, but not necessarily, measurements are combined with orbit equations to derive position estimations which are optimal or of sufficient quality.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices such as smartphones may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may for example comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations, which are described in the context of separate embodiments may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof, can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example and instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.), or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include apparatus whether hardware, firmware or software which is configured to perform, enable or facilitate that operation or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g. operation described herein may have all characteristics and attributes described or illustrated herein or according to other embodiments, may have any subset of the characteristics or attributes described herein.

1-49. (canceled)

50. A navigation system comprising:
at least one terminal configured to at least once transmit, to a communicant, via n>=1 satellite/s, a request for a reply transmission and wherein the communicant, responsively, at least once transmits a response transmission to the terminal,
wherein the terminal measures the response transmission's time of arrival and determines at least one of:
a round-trip time characterizing the terminal's own communication, via each of the satellite/s, with the communicant, and/or
the terminal's own range from each of the satellite/s,
and wherein the terminal is configured to derive self-orientation data from at least said round-trip time and from internal delay and ranging data characterizing the at least one satellite and the communicant,
wherein, based on, at most, the relaying role of the satellites, the communicant determines:
a. the positions of the satellites; and
b. the satellites' internal delays, by comparing round-trip time obtained by communication-based ranging and round-trip time obtained by a ranging method other than communication-based ranging,
thereby to avoid reliance on satellite cooperation.

51. A system according to claim 50, wherein said communicant comprises a central station serving plural terminals.

52. The system of claim 50, wherein the terminal has an internal clock.

53. A system according to claim 50, wherein said self-orientation data comprises self-positioning information regarding said terminal's position.

54. A method for self-orientation of a terminal in time or space, the method comprising:
providing a communicant central station to which a terminal sends at least one request via each of at least one respective relay satellites, and wherein the central station, responsive to said at least one request, sends at least one response to the terminal, via said at least one satellite, thereby to define a round-trip from the terminal to the communicant central station and back;
at the terminal, for each of at least one respective satellites, measuring time of arrival and/or round-trip time;
providing the terminal with data from which time elapsed between reception of the terminal's transmission by the satellite, and the transmission of the station's reply by satellite can be derived, and accordingly,
determining a round-trip time including a duration of the round-trip via said at least one respective satellites; and
deriving self-orientation data including at least one of:
synchronization data including a difference between the terminal's internal clock's current time, and a reference time system; and
the terminal's x, y location,
wherein the terminal synchronizes its own clock with the communicant's time system.

55. The method of claim 54, wherein the data from which said elapsed time can be derived includes at least one of:
internal delay characterizing the communicant central station and each of at least one respective satellites;
the positions of the station and of the satellite;
the travel time; and
a sum of the total travel time and the internal delays.

56. The system of claim 50, wherein said at least one satellites, whose communication services are used by the terminal, comprise one satellite or two satellites or three satellites.

57. A system according to claim 50, wherein said self-orientation data comprises synchronization data including a difference between the terminal's internal clock's current time, and a reference time system.

58. The system of claim 50, wherein said response transmission includes internal delay data characterizing the at least one satellite and/or the central station.

59. The system of claim 50, wherein said self-orientation data comprises x, y data which enables the terminal to perform auto-positioning.

60. The system of claim 50, wherein said self-orientation data comprises data which enables the terminal to synchronize its own internal clock to a time standard external to the terminal.

61. The system of claim 50, wherein the communicant serves more than 1 terminal.

62. The system of claim 50, wherein the terminal at least once transmits “location measurement” requests to the ground station which, responsively, sends to the terminal, at least once, the position of the (>=2) satellites, and information from which it is possible to derive the time elapsed from the reception of the terminal's transmission by each individual satellite from among the at least one satellites, to the relay from said individual satellite to the terminal of the station's reply transmission.

63. The system of claim 50, wherein the satellite/s includes at least first and second satellites, and at least the first satellite provides both an uplink and a downlink, and at least the second satellite provides a single communication link, either downlink or uplink but not both, totaling at least 2 links provided by the at least first and second satellites.

64. The system of claim 50, wherein the satellite/s includes at least 3 satellites, each of which provides a single (either downlink or uplink but not both) communication link, totaling at least 3 links provided by the at least 3 satellites respectively and wherein the at least 3 links include at least one uplink and at least one downlink.

65. The system of claim 50, wherein the terminal comprises a moving terminal and wherein at least 2 transactions, each including at least one request and response, are used each time the terminal derives self-orientation data.

66. The system of claim 50, wherein barometric altitude is known and wherein the terminal uses said altitude to determine a third range, from the center of Earth, and then determines its own location accordingly.

67. A system according to claim 50, wherein only the terminal computes and knows its own position, and the communicant does not compute or know the terminal's own position.

68. A system according to claim 50, wherein said communicant comprises a satellite that relays the terminal's transmission back to the terminal, and there is no other satellite involved in the communication loop.

69. A computer program product, comprising a non-transitory tangible computer readable medium having computer readable program code embodied therein, said computer readable program code adapted to be executed to implement a method for self-orientation of a terminal in time or space, wherein at the terminal, for each of at least one respective satellites, time of arrival and/or round-trip time is measured, wherein a communicant is provided to which a terminal sends at least one request via each of at least one respective satellites, and wherein the central station, responsive to said at least one request, sends at least one response to the terminal, via said at least one satellite, thereby to define a round-trip from the terminal to the communicant central station and back, and wherein the method comprises:
according to data from which time elapsed between reception of the terminal's transmission by the satellite, and the transmission of the station's reply by satellite can be derived, with which the terminal is provided:
determining a round-trip time including a duration of the round-trip via said at least one respective satellites; and
deriving self-orientation data including at least one of:
synchronization data including a difference between the terminal's internal clock's current time, and a reference time system; and
the terminal's x, y location,
wherein the round trip includes more than two nodes and plural segments.
